(19) United States
(12) Patent Application Publication
(10) Pub. No.: US 2025/0168483 A1
(43) Pub. Date: May 22, 2025

(54) METHOD, DEVICE, COMPUTER DEVICE, AND STORAGE MEDIUM FOR CONTROLLING GIMBAL RECORDER

(71) Applicant: Arashi Vision Inc., Shenzhen (CN)

(72) Inventors: Longxiang MA, Shenzhen (CN); Peng ZHANG, Shenzhen (CN); Jun HOU, Shenzhen (CN); Weijun ZHANG, Shenzhen (CN)

(73) Assignee: Arashi Vision Inc., Shenzhen (CN)

(21) Appl. No.: 18/948,910

(22) Filed: Nov. 15, 2024

(30) Foreign Application Priority Data
Nov. 16, 2023 (CN) 202311532482.0

(51) Int. Cl. H04N 23/61; G06T 7/20; G06T 7/70; G06V 10/75; H04N 23/695

(52) U.S. Cl. CPC H04N 23/61; G06T 7/20; G06T 7/70; G06V 10/751; H04N 23/695; G06T 2207/30241; G06T 2207/30242

(57) ABSTRACT

A method for controlling a gimbal recorder to record a game may include detecting motion information of moving objects in a moving object group and motion information of a target ball in the game, the moving objects comprising players of the game; determining group motion information of the moving object group according to the motion information of the moving objects; determining transition information according to the group motion information of the moving object group and/or the motion information of the target ball; and controlling at least one of orientation or shooting parameters of the gimbal recorder according to the transition information so as to keep the target ball within a frame captured by the gimbal recorder.

### CROSS-REFERENCE TO RELATED APPLICATION

The present application claims the priority of Chinese Patent Application No. CN202311532482.0, filed on Nov. 16, 2023, the content of which is incorporated herein by reference in its entirety.

### TECHNICAL FIELD

The present application relates to the field of image processing technology, and in particular, to a method, device, computer device, a storage medium and a computer program product for controlling a gimbal recorder.

### BACKGROUND

In sports-related application scenarios, there is a demand for video recording, that is, users want to record key moments such as scoring, attack and defense transitions and other highlight scenes during the game. Due to small field of view (FOV) of the mobile phone, it is difficult to include entire playing field in one image. To record a video of the entire playing field, a user can only manually move the camera to keep up with the movement of the crowd.

### SUMMARY

A method, device, computer device, computer-readable storage medium and computer program product are provided for controlling a gimbal recorder in order to improve stability of recording.

In one embodiment, a method for controlling a gimbal recorder to record a game may include detecting motion information of moving objects in a moving object group and motion information of a target ball in the game, the moving objects comprising players of the game;

determining group motion information of the moving object group according to the motion information of the moving objects; determining transition information according to the group motion information of the moving object group and/or the motion information of the target ball; and controlling at least one of orientation or shooting parameters of the gimbal recorder according to the transition information so as to keep the target ball within a frame captured by the gimbal recorder.

In one embodiment, the present application provides a gimbal. The gimbal may include at least one memory to store a computer program; and at least one processor configured to, when executing the computer program: detect motion information of moving objects in a moving object group and motion information of a target ball in the game, the moving objects comprising players of the game; determine group motion information of the moving object group according to the motion information of the moving objects; determine transition information according to the group motion information of the moving object group and/or the motion information of the target ball; and control at least one or more of a rotation direction, a rotation angle or a rotation speed of the gimbal according to the transition information.

In one embodiment, the present application also provides a gimbal recorder, comprising: a recorder to capture a video of a game; a gimbal to control orientation and/or shooting parameters of the recorder; at least one memory to store a computer program; and at least one processor configured to, when executing the computer program:

detect motion information of moving objects in a moving object group and motion information of a target ball in the game, the moving objects comprising players of the game;
determine group motion information of the moving object group according to the motion information of the moving objects;
determine transition information according to the group motion information of the moving object group and/or the motion information of the target ball; and
controlling at least one of orientation or shooting parameters of the gimbal recorder according to the transition information so as to keep the target ball within a frame captured by the gimbal recorder.

In one embodiment, the present application also provides a handheld gimbal, comprising a motor and a processor, wherein the motor is used to control the rotation of the gimbal, and the processor implements the method for controlling the gimbal recorder to record the game in one of embodiments of the present application when executing a computer program.

In one embodiment, the present application also provides a handheld gimbal, which includes a motor, and the motor is used to control the rotation of the gimbal. A terminal processor installed on the handheld gimbal is used to implement the method for controlling the gimbal recorder to record the game in one of embodiments of the present application when executing the computer program.

In one embodiment, the present application further provides a computer device, wherein the computer device comprises at least one memory and at least one processor, wherein the at least one memory stores a computer program, and when the at least one processor executes the computer program, the method of for controlling the gimbal recorder to record the game in one of the embodiments of the present application is implemented.

In one embodiment, the present application further provides a non-transitory computer-readable storage medium having a computer program stored thereon, which, when executed by a processor, implements the method for controlling the gimbal recorder to record the game in one of embodiments of the present application.

In one embodiment, the present application further provides a computer program product, which includes a computer program, and when the computer program is executed by at least one processor, the method for controlling the gimbal recorder to record the game in one of embodiments of the present application is implemented.

The above-mentioned method, device, computer device, storage medium and computer program product detect the movement trajectory of each moving object in the moving object group based on multiple frames of images, so that the multi-target detection method can be directly applied to the movement trajectory detection of each moving object, and accordingly recognition speed and accuracy are guaranteed by a relatively mature detection method; on this basis, the group motion information of the moving object group is determined according to the movement trajectory of each moving object, and the group motion information is obtained by further performing data statistics through the movement trajectory of each moving object; and the group motion information can reflect the movement trend of the target ball, and will not affect the accuracy due to occlusion. Therefore, according to the transition situation that the group motion information conforms to, when the target ball is frequently occluded, the group transition direction can be accurately and quickly determined to better ensure the stability of image acquisition.

It should be understood that the above general description and the detailed description that follows are exemplary and explanatory only and do not limit the present application.

### BRIEF DESCRIPTION OF THE DRAWINGS

In order to explain the technical features of embodiments of the present disclosure more clearly, the drawings used in the present disclosure are briefly introduced as follow. Obviously, the drawings in the following description are some exemplary embodiments of the present disclosure. Ordinary person skilled in the art may obtain other drawings and features based on these disclosed drawings without inventive efforts.

FIG. 1 is an application environment diagram of a method of controlling a gimbal recorder in one embodiment;

FIG. 2 is a schematic flow chart of a method of acquiring images of a target ball in one embodiment;

FIG. 3a is a schematic diagram of a right transition in a game in one embodiment;

FIG. 3b is a schematic diagram of a left transition in a game in one embodiment;

FIG. 4 is an application environment diagram of a transition process in one embodiment;

FIG. 5 is an application environment diagram of a transition process in another embodiment;

FIG. 6a is a schematic diagram of a moving object throwing a ball in a long-trajectory ball movement scene in one embodiment;

FIG. 6b is a schematic diagram of a moving ball travelling in air in a long-trajectory ball movement scene in one embodiment;

FIG. 6c is a schematic diagram of a moving object catching a ball in a long-trajectory ball movement scene in one embodiment;

FIG. 7a is a schematic diagram of a gimbal in a left transition during a transition process in one embodiment;

FIG. 7b is a schematic diagram of a gimbal in a right transition during a transition process in one embodiment;

FIG. 8 is a structural block diagram of a gimbal recorder in one embodiment;

FIG. 9 is a diagram showing an internal structure of a computer device in one embodiment.

### DETAILED DESCRIPTION

In order to make the purpose, technical solution and advantages of the present application more clearly understood, the present application is further described in detail below in conjunction with the accompanying drawings and embodiments. It should be understood that the specific embodiments described herein are only used to explain the present application and are not used to limit the present application.

During a game, a user usually wants to record key moments such as goal time, attack and defense transition and other highlight moments during the game. During the attack and defense transition, the target ball is frequently blocked. Accordingly, if a gimbal is used to rotate the recording device based on the target ball to collect images, stability of the collected images is usually poor.

A handheld shooting system including a gimbal may be used to shoot sports scenes, which can reduce shooting instability caused by accidental shaking to a certain extent. However, due to the limited field of view of the shooting device, it is difficult to include the entire field in an image, and manual frequent lens movement is required to capture the highlight moments. However, highlight moments are usually accompanied by a faster pace of the game, and the manual shooting process can easily miss the above highlight moments. At the same time, during the shooting process, any unexpected shaking or movement may lead to improper framing.

Since the highlight moments are usually inseparable from the moving ball, one embodiment of the present application records the above highlight moments by detecting and tracking a target ball, that is, controlling rotation of the gimbal based on motion information of the target ball.

Furthermore, the presence of heads in cluttered audience seats, stationary spheres on the ground beside the field, and spheres in posters on the wall may trigger the detector and then the tracker, making it difficult to accurately determine the target ball; on the other hand, for moments such as attack and defense transition where the target ball is blocked, tracking the target ball becomes more difficult.

To solve the above and other problems, another embodiment of the present application detects an overall movement trend of the group during the attack and defense transition process, so as to control the gimbal movement based on the overall movement trend of the group in the attack and defense transition moment. The gimbal can adjust a direction of a recorder by rotation, and because the gimbal communicates with the recorder, it can control shooting parameters such as focal length of the recorder.

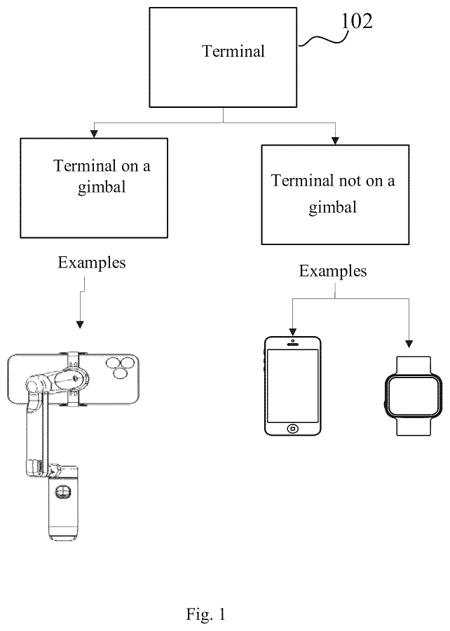

A method controlling a gimbal recorder provided in one embodiment of the present application can be applied in the application environment as shown in FIG. 1. Among them, a terminal 102 can be, but is not limited to, a camera, a video cameras, a panoramic camera, a sports camera, a personal computer, a laptop, a smart phone, a tablet computer, a gimbal body or a portable wearable device. The portable wearable devices can be a smart watch, a smart bracelet, a head-mounted device, etc. The terminal 102 can be fixed to the gimbal body by welding or the like, and can also be detachably connected or rotatably connected to the gimbal body. Optionally, the gimbal body can be a handheld gimbal; the handheld gimbal can be configured with or have a gimbal bracket, and the gimbal bracket can be a tripod or a monopod.

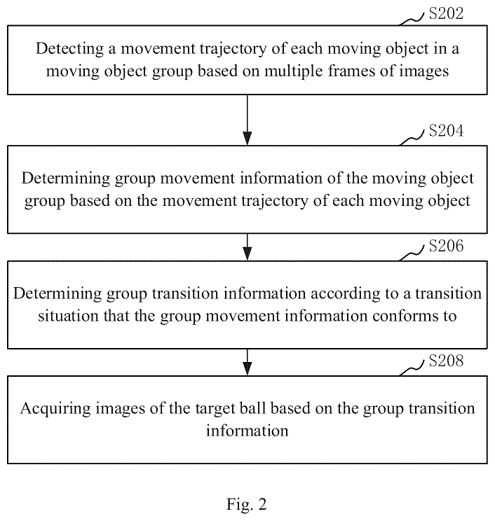

In one embodiment, as shown in FIG. 2, a method for acquiring an image of a target ball is provided, which is described by taking the method applied to the terminal 102 in FIG. 1 as an example, and includes the following steps:

Step 202: detecting a movement trajectory of each moving object in a moving object group based on multiple frames of images.

The multiple frames of images are images acquired by the terminal at different times; optionally, images acquired in sequence at consecutive times can be taken as the multiple frames of images; images acquired in sequence with a certain time interval can also be taken as the multiple frames of images; images collected in real time at different times can also be taken as the multiple frames of images.

The moving object group is a group of objects that can control the target ball to move; the moving object group may include multiple moving objects. The moving object group can control the target ball to move by performing certain actions, or enable the target ball to trigger corresponding ball events.

Optionally, the moving objects can be imaged based on motion information of multiple moving objects, and the imaged moving objects are determined as the moving objects in the moving object group. Optionally, the moving objects contained in the moving object group are variable, and the movement trajectory of the moving objects is formed by known positions of the moving objects in different images, and then the unknown positions are determined by the movement trajectory of the moving objects. Among them, the moving objects that exist in some frames have known positions in these frames, while the moving objects do not exist in other frames. In this case, the positions of the moving objects in the above-mentioned other frames are unknown positions.

The movement trajectory of each moving object is a position sequence of each moving object arranged in time sequence; the position sequence can be a coordinate sequence or an image region sequence, the image region sequence includes image regions arranged in time sequence, and each image region is used to represent a position of each moving object in the reference image at a certain time. In one embodiment, the position sequence of each moving object can be an ID sequence of each person.

In one embodiment, the detecting movement trajectory of each moving object in the moving object group based on multiple frames of images includes: using a ball detector to identify people in the images frame by frame; using a target detection algorithm, the detector algorithm including, but is not limited to, You Only Look Once (YOLO) and Single Shot MultiBox (SSD); using a multi-targets tracking algorithm to assign a tracking ID to each person, analyzing movement trajectory of each ID, filtering out stationary balls on the sidelines and people with small movements, and obtaining the movement trajectory of each moving object in the moving object group.

Step 204: determining group motion information of the moving object group based on the movement trajectory of each moving object.

The group motion information is motion information generated based on the motion information of the moving objects in the moving object group; the group motion information is used to characterize a movement trend of the moving object group; the moving objects in the moving object group refer to multiple moving objects belonging to the moving object group. Optionally, the group motion information is generated for the moving objects in the moving object group; wherein the group motion information may include, but is not limited to, statistical results of position change information of the moving objects and group position change information determined based on the position change information of the moving objects. Specifically, the above statistical results may be obtained by performing statistics on position change information of the moving objects in certain directions; the above group position change information may be obtained by performing averaging and other processing on the position change information of the moving objects in certain directions in chronological order.

In one embodiment, the determining group motion information of the moving object group based on the movement trajectory of each moving object includes: according to the movement trajectory of each moving object, performing statistics on position change information of each moving object in each transition direction to obtain moving object information in each transition direction; and determining the group motion information characterized by the moving object information in each transition direction. Thus, the position change information of the moving object is first determined, and then statistics on the position change information is performed to obtain the moving object information in each transition direction, so that the group motion information can be more accurately calculated at individual position perspective.

In one embodiment, the determining group motion information of the moving object group based on the movement trajectory of each moving object includes: determining the position of each moving object at different times in a sequence of image regions of each moving object arranged in chronological order; averaging the position of each moving object at each time to obtain the group position information at each time; determining the group position information at each continuous time according to the position change of the group position information at each time; accumulating the group position information at each continuous time to obtain the group motion information of the moving object group. Thus, the group position information is first determined, and then the group position information at each continuous time is determined. By accumulating the group position information at each continuous time, the group motion information of the moving object group is obtained, thereby realizing accurate calculation of the group motion information from the group position perspective. Optionally, the analysis methods from the two perspectives of individual position and group position respectively each have their own limitations, but both can guarantee identification speed and accuracy.

Step 206: determining group transition information according to a transition situation that the group motion information conforms to.

The group transition information is a transition result determined based on the group motion information. The group transition information belongs to one of a transition type or a non-transition type. The transition type is used to indicate that the image acquisition process requires a transition; the non-transition type is used to determine that the image acquisition process does not require a transition; the group transition information of the non-transition type can be non-existent data or characterized by some prompt information. Optionally, when the group motion information conforms to the transition situation, a group transition direction, a group transition speed and other information can be determined according to the transition situation that the group motion information conforms to; when the group motion information does not conform to the transition situation, the group motion information is not used to control the image acquisition.

In one embodiment, the determining group transition information according to a transition situation that the group motion information conforms to includes: judging whether the group motion information of the moving object group in multiple frames triggers a transition event; if so, characterizing the transition situation that the group motion information conforms to according to the transition event, and determining the group transition information of the transition type through the transition situation; if not, obtaining the group motion information of the non-transition type.

Optionally, the group transition information can be characterized by a transition signal; the transition signal can be used only to characterize that the image acquisition process requires a transition, or can be used to characterize that the image acquisition process requires a transition and the corresponding group transition direction. Optionally, the transition signal can be sent by the terminal to the gimbal body, or by the processor of the gimbal body when controlling the movement of its own motor.

Optionally, the determining group transition information according to a transition situation that the group motion information conforms to includes: determining the group transition information based on individual position statistics that the group motion information conforms to; and/or determining the group transition information based on group displacement change situation that the group motion information conforms to.

Step 208: acquiring images of the target ball based on the group transition information.

The target ball is a ball in movement. Optionally, the target ball is a ball in a certain sport, which belongs to a certain preset ball type; illustratively, the target ball belongs to a basketball.

In one embodiment, the acquiring images of the target ball based on the group transition information includes: if the group transition information is used to determine the transition, acquiring images in a transition direction opposite to the previous transition direction.

In another embodiment, the acquiring images of the target ball based on the group transition information includes: controlling rotation of the gimbal according to the transition direction contained in the group transition information; acquiring images of the target ball during the rotation of the gimbal; wherein the gimbal rotation may be a preset value or may be dynamically changed.

In one embodiment, the controlling the rotation of the gimbal according to the transition direction contained in the group transition information includes: if the transition direction contained in the group transition information is a first transition direction, controlling the gimbal to rotate toward the first transition direction; if the transition direction contained in the group transition information is a second transition direction, controlling the gimbal to rotate toward the second transition direction.

The process of acquiring the image of the target ball may be carried out through the gimbal, which is provided with a camera movement button, which can be a mechanical button on the gimbal, a virtual button on the mobile phone image, or a virtual button on the gimbal image.

Since the process of acquiring images of the target ball may be carried out through the gimbal, the gimbal is equipped with a camera movement button, which can be used for manual intervention in scenarios such as stealing the target ball and other scenarios that cause the transition signal to fail.

In one embodiment, the movement trajectory of each moving object in the moving object group is detected based on multiple frames of images, so that the multi-target detection method can be directly applied to the movement trajectory detection of each moving object, and the recognition speed and accuracy are guaranteed by a relatively mature detection method; on this basis, the group motion information of the moving object group is determined according to the movement trajectory of each moving object, and the group motion information is obtained by further performing data statistics through the movement trajectory of each moving object; and the group motion information can reflect the movement trend of the target ball, and will not affect accuracy due to occlusion. Therefore, according to the transition situation that the group motion information conforms to, when the target ball is frequently occluded, the group transition direction can be accurately and quickly determined to better ensure stability of image acquisition.

In one embodiment, the analysis method from the individual position perspective is described in detail. The determining group motion information of the moving object group according to the movement trajectory of each moving object includes: determining a target image region and different transition critical positions in a reference image of multiple frames of images; in the movement trajectory of each moving object passing through the target image region, the movement trajectory of the moving object intersecting at different transition critical positions is respectively counted to obtain the number of moving objects in different transition directions.

Correspondingly, the determining the group transition information according to the transition situation that the group motion information conforms to includes: determining the group transition direction according to a transition interval to which the number of movement objects in different transition directions belongs.

The reference image is an image of a group of moving objects, which is the image where the movement trajectory of each moving object is located. Optionally, a sequence of image areas of each moving object can be arranged in chronological order to form a movement trajectory of each moving object; and the image where the movement trajectory of each moving object is located is the reference image. Optionally, the reference image can be one frame of the multiple frames of images, or an image generated based on the multiple frame of images; illustratively, the reference image can be an image within a certain time period, or an image obtained by averaging pixel positions of multiple frame of images.

The transition critical position is a critical position for transition judgment in the reference image. Optionally, the transition critical position is a critical line in a direction of a certain side of the reference image and perpendicular to the direction of this side; optionally, the transition critical position is a critical line in the width direction of the reference image and perpendicular to the width direction of the reference image; optionally, the image width of the reference image can be computed with a transition critical position ratio to obtain the transition critical line in the image width direction. Exemplarily, an image width of the reference image is Width, the image width is a positive direction of the pixel x-axis, the pixel x-axis coordinate interval is (0˜Width), and 0.2*Width and 0.8*Width are set as the critical lines where the image critical position is located. Optionally, the transition critical position is defined according to a certain position on the court.

The target image region is a region where the target position of the reference image is located; optionally, the target image region can be an image region within a certain range of the target position, and this range can be a fixed value or can change dynamically based on image attributes such as image width and number of pixels.

The transition direction is at least one expected conversion direction of the image acquisition process; optionally, the transition direction is determined based on at least one set of opposite directions, and the image acquisition process can be controlled to be reversible through the set of opposite directions. Optionally, each transition direction corresponds to at least one field critical position, and a length side direction of the reference image that is closest to and does not intersect the transition critical position is the transition direction; for example: a certain transition critical position is set along a width direction of the reference image, and is perpendicular to the width direction of the reference image, and is closest to a left direction of the reference image, then the field critical position corresponding to the transition critical position is the left direction; a certain transition critical position is set along the width direction of the reference image, and is perpendicular to the width direction of the reference image, and is closest to a right direction of the reference image, then the field critical position corresponding to the transition critical position is the right direction.

The transition interval is a numerical interval set for the number of moving objects in different transition directions. When the number of moving objects in different transition directions respectively belongs to the transition interval, it can be determined that the group transition information is of the transition type, and the group transition direction can be generated.

In this embodiment, in the reference image of multiple frames of images, the target image region and different transition critical positions are determined, and the group moving change trend of the group moving objects with different transition directions can be reflected through the different transition critical positions; in the moving trajectories of the moving objects that pass through the target image region, the moving trajectories of the moving objects that intersect at different transition critical positions are respectively counted, and the number of moving objects in different transition directions is obtained to determine the group motion information from statistical perspective of the individual positions; on this basis, the group transition direction is determined according to the transition interval to which the number of moving objects in different transition directions belongs, and it can be determined that the image acquisition process needs to be transitioned, and the group transition information is clarified. Therefore, the group motion information can be more accurately calculated from the perspective of the individual positions to ensure recognition accuracy of the group transition information.

A critical value of the transition interval includes a first critical value and a second critical value. The first critical value is greater than the second critical value; the first critical value and the second critical value are respectively used to limit the number of moving objects in the transition direction, and the first critical value and the second critical value correspond to opposite trends of the movement of the group of objects. Optionally, the first critical value is 4, 5, or 6 moving objects, and the second critical value is 1 or 2 moving objects.

In one embodiment, among the movement trajectories of the moving objects passing through the target image region, counting respectively the movement trajectories of the moving objects intersecting at different transition critical positions to obtain the number of moving objects in different transition directions include: among the movement object trajectories passing through the target image region, counting the movement object trajectories intersecting at a first transition critical position to obtain the number of moving objects in the first transition direction; among the movement object trajectories passing through the target image region, counting the movement object trajectories intersecting at a second transition critical position to obtain the number of moving objects in the second transition direction.

In one embodiment, the determining the group transition direction according to the transition situation that the group motion information conforms to includes: if the number of moving objects in the first transition direction is greater than a first critical value, and the number of moving objects in the second transition direction is less than a second critical value, then the group transition direction is determined to be the first transition direction; if the number of moving objects in the first transition direction is less than the second critical value, and the number of moving objects in the second transition direction is greater than the first critical value, then the group transition direction is determined to be the second transition direction; wherein the first transition direction and the second transition direction are opposite directions.

The first transition direction and the second transition direction are a set of opposite directions; the first transition direction is used to characterize that the transition direction of the image acquisition is the first transition direction, and it is necessary to control the imager to rotate in the first transition direction; the second transition direction is used to characterize that the transition direction of the image acquisition is in the second transition direction, and it is necessary to control the imager to rotate to the second transition direction; exemplarily, the first transition direction is the left transition direction, and the second transition direction is the right transition direction.

In one embodiment, if the number of moving objects in the first transition direction is greater than the first critical value, and the number of moving objects in the second transition direction is less than the second critical value, it means that the majority of moving objects in the moving object group move toward the first transition direction, and a minority of moving objects in the moving object group move toward the second transition direction, and thus the group transition direction is determined to be the first transition direction. If the number of moving objects in the first transition direction is less than the second critical value, and the number of moving objects in the second transition direction is greater than the first critical value, it means that a minority of moving objects in the moving object group move toward the first transition direction, and a majority of moving objects in the moving object group move toward the second transition direction, and thus the group transition direction is determined to be the second transition direction.

In one embodiment, the determining the group motion information of the moving object group according to the movement trajectory of each moving object includes: an image width of the reference image is Width, the image width is in a positive direction of the pixel x-axis, the interval of the pixel x-axis coordinate is (0˜Width), and 0.2*Width and 0.8*Width are set as the critical lines where the critical positions of the images are located. The movement trajectory of the moving object in a historical time period (such as 2 seconds) is analyzed. When the movement trajectory of the moving object passes through the critical line 0.2*Width from the center area of the image, it is considered that the transition direction of the moving object at the current time is the left direction; when the movement trajectory of the moving object passes through the critical line 0.8*Width from the center area of the image, it is considered that the transition direction of the moving object at the current time is the right direction.

Correspondingly, the determining the group transition direction according to the transition interval to which the number of moving objects in different transition directions belongs includes: if the number of moving object IDs transitioning in the first transition direction is equal to or exceeds the first critical value, and the number of moving object IDs in the second transition direction is lower than the second critical value, it is considered that the moving object group has a transition trend, that is, the transition event is recognized, and the algorithm outputs a transition signal.

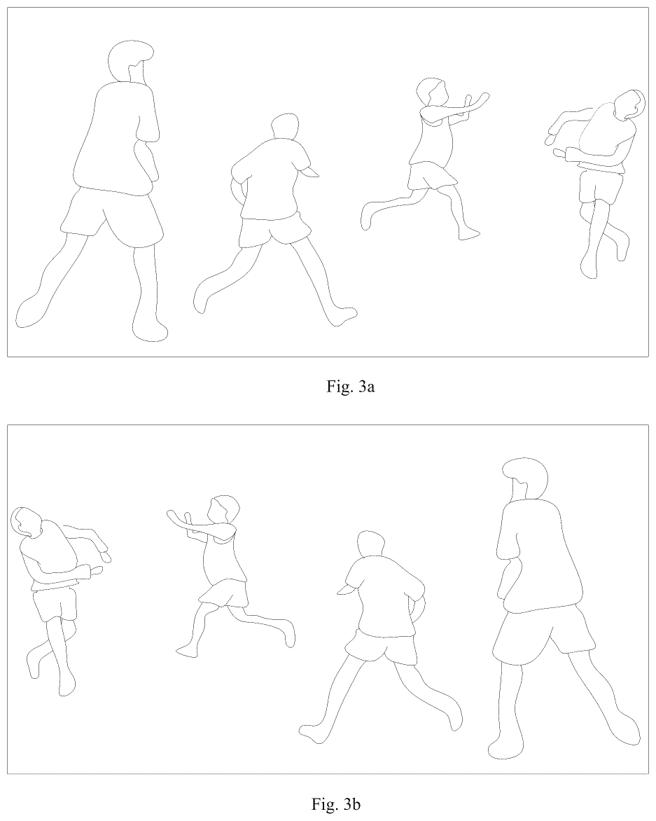

In one embodiment, as shown in FIG. 3 (a), the number of moving objects in the left transition direction is one, and the number of moving objects in the right transition direction is three. In this case, if the first critical value is three and the second critical value is two, the group transition direction belongs to the transition type, and the group transition direction is that the gimbal turns to the right; if the first critical value is four, or the second critical value is one, the group transition direction belongs to the non-transition type.

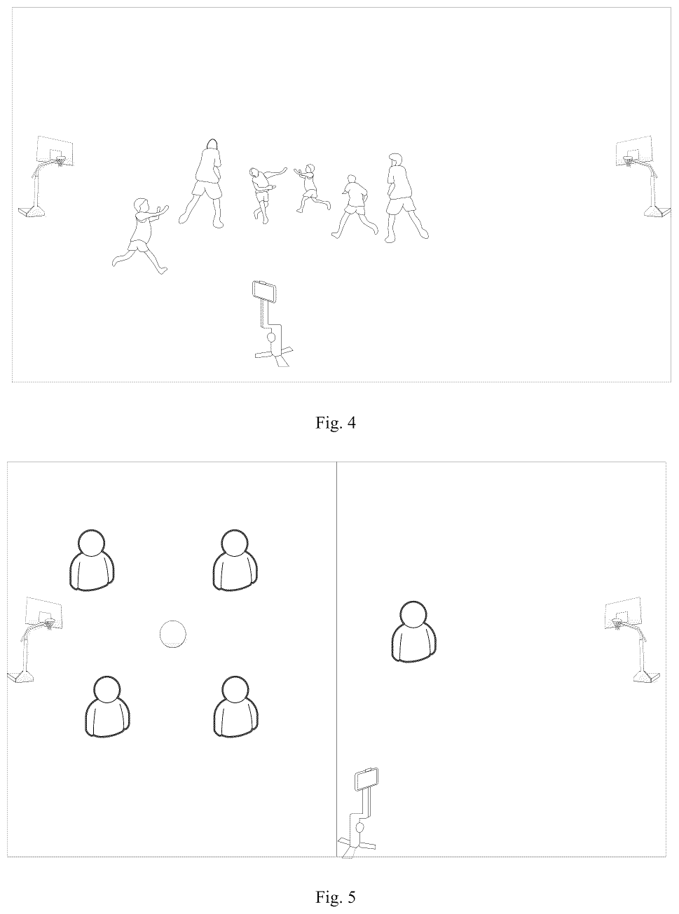

In another embodiment, as shown in FIG. 3 (b), the number of moving objects in the left transition direction is three, and the number of moving objects in the right transition direction is one; in this case, if the first critical value is three, and the second critical value is two, the group transition direction belongs to the transition type, and the gimbal transitions to its left side; if the first critical value is four, or the second critical value is one, the group transition direction belongs to the non-transition type. Exemplarily, the application scenario of FIG. 3 (b) during shooting is shown in FIG. 4.

Optionally, as shown in FIG. 5, a terminal in this application scenario is set close to the midfield line of the court. At this time, in the image taken by the terminal, no matter how the camera's field of view changes, the number of moving objects in the left transition direction is less than or equal to two, and the number of moving objects in the right transition direction is less than or equal to two. In this case, if the first critical value is three and the second critical value is two, the group transition direction belongs to the non-transition type and no transition is required.

Therefore, between the number of moving objects in the first transition direction and the number of moving objects in the second transition direction, the maximum value of the two needs to be compared with the first critical value, and the minimum value of the two needs to be compared with the second critical value. By comparing the number of moving objects in these two transition directions at the same time, misjudgment can be avoided and higher determination accuracy can be ensured.

In another embodiment, the analysis method for the group position is described in detail. The determining the group motion information of the moving object group according to the movement trajectory of each moving object includes: determining individual position of each moving object at a same time according to the movement trajectory of each moving object at different times; generating a group position at the same time according to the individual position of each object at the same time; generating group displacements of at least two groups of adjacent times according to group positions of the at least two groups of adjacent times.

Correspondingly, the determining the group transition direction according to the transition situation that the group motion information conforms to includes: if the group displacements of at least two groups of adjacent times have the same transition direction, and in the same transition direction, the group displacements of the at least two groups of adjacent times respectively exceed a transition length threshold corresponding to the group displacements, then it is determined that the group transition information includes the same transition direction.

The individual position of the object is the position of each moving object; it can be determined based on the position area where each moving object is located, or it can be determined based on a coordinate position in the reference image. The individual position of the object is a detection result of the target detection. Optionally, the individual position of the object is a center point of a tracking frame (a person detection frame) stored in a tracking sequence.

The transition length threshold is a threshold used to judge the transition situation; when the group displacements of at least two groups of adjacent times respectively exceed the transition length threshold corresponding to the group displacement, a transition is required; when the group displacement of only one of the at least two groups of adjacent times exceeds the transition length threshold corresponding to the group displacement, no transition is required.

The group position is a position obtained by performing statistics based on the individual positions of the objects, and the group displacement is a displacement generated based on the group positions; optionally, the individual positions of the objects and the group position are both coordinate positions, and the group displacement can be a difference vector or difference matrix of the group positions at adjacent times. Optionally, the group displacement can be a two-dimensional displacement, in which case the group displacement is a displacement along the x-axis.

Adjacent times may be adjacent in terms of timestamps, or may be times separated by a preset time period, or may be continuous times. A group of adjacent times includes two times, and at least two groups of adjacent times include at least three adjacent times.

In one embodiment, the determining the individual object position of each moving object at the same time according to the movement trajectories of each moving object at different times includes: in the movement trajectories of each moving object at different times, selecting the individual object positions with the same timestamp according to each moving object.

In one embodiment, the generating the group position at the same time based on the individual positions of the objects at the same time includes: averaging the individual positions of the objects at the same time to obtain the individual position averaging result; and generating the group position at the same time based on the individual position averaging result.

Optionally, the individual position averaging result can be used as the group position at the same time. Optionally, the generating the group position at the same time according to the individual position averaging result includes: at each time, according to the distance between the individual position averaging result and the individual position of each object, the individual position of the object whose distance is outside a imaging range is filtered out to obtain the filtered individual position of the object; the filtered individual position of the object is averaged to obtain the group position at the same time; wherein the imaging range can be a preset value or a value obtained in real time. In this way, the individual position of the object that is too far away from the individual position averaging result is filtered out, so that the accuracy of the group position is higher.

In one embodiment, the generating group displacements of at least two groups of adjacent times according to group positions of the at least two groups of adjacent times includes: determining group positions of at least two groups of adjacent times in time sequence among the group positions at the same time; performing difference calculation based on the group positions of at least two groups of adjacent times to obtain group displacements of the at least two groups of adjacent times; wherein the group displacement of each group of adjacent times corresponds to the group positions of the at least one group of adjacent times. Exemplarily, the group position of each group of adjacent times may be two coordinate positions, and the group displacement is a vector calculated based on the two coordinate positions.

In one embodiment, if the group displacements of the at least two groups of adjacent times have the same transition direction, and in the same transition direction, the group displacements of the at least two groups of adjacent times respectively exceed the transition length threshold corresponding to the group displacement, then it is determined that the group transition information includes the same transition direction, and the judgment process includes: if it is determined that the transition directions of the group displacements of at least two groups of adjacent times are the same, and in the above-mentioned same transition direction, the lengths of the group displacements of the at least two groups of adjacent times are both greater than the transition length threshold, then it is determined that the group transition information includes the above-mentioned same transition direction.

In an exemplary embodiment, the moving object group is a crowd, and the moving object is each mover in the moving object group; according to the moving trajectory corresponding to each moving object ID, the center points of the tracking frames (person detection frames) stored in all tracking sequences at the time are collected, and the average x-coordinate value ave_x of the center points is calculated, and the center points far from the average ave_x are filtered out, and the filtered center points are used to recalculate the average x-coordinate value at time to and record it as ave_t₀. According to the calculation method at time to, the average x-coordinate values at time t₁ and time t₂ are calculated and recorded as ave_t₁ and ave_t₂, respectively. Finally, the x-coordinate displacement between time t₀ and time t₁ is calculated and recorded as x₀₁, and the x-coordinate displacement between time t₁ and time t₂ is calculated and recorded as x₁₂. If the displacement directions of x₀₁ and x₁₂ are consistent and the total displacement exceeds the transition length threshold Dₜₕᵣ, it is considered that the crowd has a continuous overall displacement in the same direction from time t₀ to t₂, and it is considered that a transition event occurs at this time. A transition signal can be output, and the group transition information represented by the transition signal indicates the group transition direction.

In one embodiment, the movement trajectory of each moving object at different times is the result of multi-target detection, and according to the movement trajectory of each moving object at different times, the individual position of each moving object at the same time is determined, thereby realizing the refinement of the result of multi-target detection; and according to the individual position of each object at the same time, the group position at the same time is generated, so that the detection process of the individual position is changed to the detection process of the group position; according to group positions of at least two groups of adjacent times, group displacements of at least two groups of adjacent times are generated; and the group displacements of at least two groups of adjacent times have the same transition direction to reflect the transition scheme, and the group displacements of at least two groups of adjacent times respectively exceed the transition length threshold, thereby realizing the process of re-verification, so that the group transition information matches the occurrence process of the transition with higher accuracy, thereby instructing the gimbal to transition in the transition direction.

Among them, when the group motion information includes the number of moving objects in different transition directions and does not include the group displacements of at least two groups of adjacent times, the transition interval used to judge the transition situation is the first transition interval; when the group motion information does not include the number of moving objects in different transition directions and includes group displacements of at least two groups of adjacent times, the transition length threshold used to judge the transition situation is the first transition length threshold; when the group motion information includes the number of moving objects in different transition directions and includes group displacements of at least two groups of adjacent times, the transition interval is the second transition interval, and the transition length threshold is the second transition length threshold; wherein the range of the first transition interval is smaller than the range of the second transition interval, and the first transition length threshold is greater than the second transition length threshold.

In the case where the group motion information includes the number of moving objects in different transition directions and does not include group displacements of at least two groups of adjacent times, in this case, the terminal uses the detection of individual positions alone. Exemplarily, the first critical value of the first transition interval is 5, and the second critical value is 1. When the terminal uses the detection of individual positions alone, when more than 5 objects move to the right and less than 1 object moves to the left, a right transition signal is output.

In the case where the group motion information does not include the number of moving objects in different transition directions, and includes group displacements of at least two groups of adjacent times, in this case, the terminal uses the detection of the group position alone. Exemplarily, when the transition direction of group displacements of at least two groups of adjacent times is the right direction, and the total amount of the displacement of the group displacements of at least two groups of adjacent times exceeds the first transition length threshold, 0.1*img_height, a transition signal to the right direction is output; wherein img_height is the reference image height.

In the case where the group motion information includes the number of moving objects in different transition directions and includes group displacements of at least two groups of adjacent times, in this case, the terminal uses detection of individual positions and group positions at the same time.

Optionally, when the group motion information includes the number of moving objects in different transition directions and includes group displacements of at least two groups of adjacent times, the transition interval is the second transition interval, and the transition length threshold is the second transition length threshold; while the first transition interval covers the second transition interval, and the range of the first transition interval is smaller than the range of the second transition interval, and the first transition length threshold is greater than the second transition length threshold. In this case, the detection results of the individual positions and the group position are complementary, and belong to algorithm coupling use, which can further improve the recognition speed and accuracy of the transition algorithm; specifically, on the one hand, the first transition interval covers the second transition interval, and the range of the first transition interval is smaller than the range of the second transition interval, so that the range of the transition interval is relaxed, and when the number of moving objects in different transition directions is small, it can still be accurately judged; on the other hand, the first transition length threshold is greater than the second transition length threshold, so that when the group displacements of at least two groups of adjacent times are small, it can still be accurately judged.

For example, the first critical value of the first transition interval is 5, and the second critical value of the first transition interval is 1; the first critical value of the second transition interval is 3, and the second critical value of the second transition interval can remain unchanged; and in the case of the first transition length threshold of 0.1*img_height, the first transition length threshold is relaxed to 0.05*img_height. At this time, the judgment logic becomes: when the number of rightward movement is greater than or equal to 3, the number of leftward movement is less than or equal to 1, and the total amount of displacement exceeds 0.05*img_height, a rightward transition signal is output.

Thus, group motion information in three cases is formed, and each of them can be used to obtain group transition information. The terminal can apply any of the three cases separately, and when used in conjunction, its recognition precision and accuracy are better.

In one embodiment, the determining group transition information according to the transition situation that the group motion information conforms to includes: when the group motion information does not meet the group transition information generation condition, performing optical flow estimation on the moving object group according to multiple frames to obtain the optical flow displacement of each frame; accumulating the optical flow displacement of each frame to obtain an image movement feature map corresponding to the multiple frames; the image movement feature map includes multiple feature map pixels, and the direction of each feature map pixel is determined by the accumulation result of the optical flow displacement of each frame; according to the direction of each feature map pixel, counting the number of pixels of the feature map pixels displaced along the opposite transition directions respectively to obtain the number of pixels in the opposite transition directions; and determining the comparison result between the number of pixels in the opposite transition directions; the comparison result belongs to the group motion information.

The group transition information generation condition is a condition set for the correspondence between the group motion information and the group transition information. The group transition information generation condition can be set based on the number of movement trajectories of the movement objects, or whether a reference object exists.

The optical flow displacement is the result of optical flow estimation based on multiple frames, and can be used to characterize the movement trend of a moving object group. Optionally, in multiple frames, the optical flow displacement can be obtained based on brightness changes of each adjacent frame. Optionally, the optical flow estimation can be performed along a certain transition direction and an opposite transition direction of this transition direction to obtain the optical flow displacement of each frame.

The image movement feature map is the result of accumulating the optical flow displacement of multiple frames in a certain interval. Optionally, the optical flow displacement can be accumulated based on multiple frames in a certain quantity interval to obtain the image movement feature map; the optical flow displacement can be accumulated for multiple frames in a certain time interval to obtain the image movement feature map. Optionally, each pixel in the image movement feature map is obtained by optical flow estimation based on the brightness value of each pixel, or by optical flow estimation based on each pixel and its neighboring pixels.

The feature map pixel is a pixel in the image movement feature map, and each feature map pixel is used to characterize the optical flow estimation result within a certain interval. The direction of each feature map pixel is the optical flow direction; optionally, if the optical flow displacement is set along the transition direction, the direction of the feature map pixel is set along a certain transition direction. The opposite transition directions are at least one pair of opposite transition directions.

The comparison result between the numbers of pixels in opposite transition directions can be determined based on the ratio of the numbers of pixels in opposite transition directions, or based on the difference of the numbers of pixels in opposite transition directions, and the difference of the number of pixels has higher accuracy. For example, in a 1080p reference image, if there are 1000 pixels to the right and 1 pixel to the left, the ratio will reach 1000. The difference in the number of pixels can represent how many pixels have changed. While the ratio of the number of pixels cannot reflect the degree of such change, the difference in the number of pixels can reflect the corresponding degree of change.

In one embodiment, the performing the optical flow estimation of the moving object group based on multiple frames to obtain the optical flow displacement of each frame includes: in multiple frames of a certain quantity interval, estimating the optical flow between adjacent frames to obtain the optical flow displacement of each frame in this quantity interval. Exemplarily, for the Kth frame and the K+1th frame, the optical flow between the Kth frame and the K+1th frame is calculated to obtain the displacement of the moving object group in the x direction in the K+1th frame. By analogy, the optical flow results of N frames are formed for analyzing the optical flow displacement in the N frames, where N is a preset value, which can be 10, 30, etc.

In one embodiment, accumulating the optical flow displacement of each frame to obtain an image movement feature map corresponding to the multiple frames includes: for each pixel of the image, accumulating the optical flow displacement of each of the multiple frames within a certain quantity interval to obtain an image movement feature map corresponding to the multiple frames.

In one embodiment, when the comparison result is group motion information; determining the group transition information according to the transition situation that the group motion information conforms to includes: determining the group transition information according to the transition situation that the comparison result conforms to. Optionally, when the comparison result is greater than a certain threshold, it can be determined that a transition is performed; when the comparison result is less than a certain threshold, no transition is performed.

For example, the optical flow displacements of N frames are accumulated to obtain the movement feature map of the optical flow in the x direction; the optical flow threshold is set to Thr, and the movement amount (the length of the optical flow displacement) less than the threshold Thr is set to 0. The difference between the number of pixels moving to the left and the number of pixels moving to the right is calculated. When the difference exceeds a certain proportion of the total number of pixels in the image, it is considered that the target in the image has moved in a certain direction as a whole, that is, an occurrence of the attack and defense conversion event is recognized, and the algorithm outputs a transition signal.

Therefore, through the optical flow calculation method, there is no need to rely on the detection algorithm of the moving object group, and the corresponding group transition information can still be determined relatively accurately to ensure the recognition accuracy. In this process, the moving object group is a prominent target in the movement process. Through the group motion information of the moving object group, it can accurately reflect whether a scene transition is needed and will not be affected by the occlusion relationship; thus, it can more accurately determine whether a transition is needed to make the process of acquiring images more stable.

In one embodiment, condition for generating group transition information is defined. Before performing optical flow estimation on a group of moving objects based on multiple frames of images, the method includes: in the case of detecting the movement trajectories of multiple moving objects based on multiple frames of images, determining that the movement trajectories of the multiple moving objects satisfy a small number trajectory condition; and/or it is detected that multiple frames satisfy a reference object lacking condition.

The small number trajectory condition is a trajectory number standard used to characterize that there are few movement trajectories for multiple moving objects in multiple frames. The reference object lacking condition is a detection condition for a certain reference object; optionally, the reference object is designed for a sports scene; illustratively, in a basketball scene, the reference object can be a basket or a backboard.

In one embodiment, determining that the movement trajectories of multiple moving objects satisfy a small number trajectory condition includes: determining that the number of movement trajectories of the multiple moving objects is less than a preset small number of trajectory threshold of the terminal; or determining that the number of movement trajectories of the multiple moving objects is less than a value input before the image is captured.

In one embodiment, the detecting that multiple frames satisfy a reference object lacking condition includes: if a preset number of frames among the multiple frames are not detected, then the multiple frames satisfy the reference object lacking condition; if features of the reference object are not extracted based on the multiple frames, then the multiple frames satisfy the reference object lacking condition.

Therefore, through the small number trajectory condition and the reference object lacking condition, scenes such as the gimbal being blocked at a close distance and the backboard being blocked by people are set. In these scenes, the group movement trend can be calculated more accurately through optical flow estimation.

In one embodiment, the determining group transition information based on a transition situation that group motion information conforms to includes: when the group motion information does not meet the group transition information generation condition, determining a pixel number difference based on the difference between the numbers of pixels in opposite transition directions; the number of pixels in the opposite transition directions are obtained based on multiple frames; the number of pixels in the opposite transition directions belong to the group motion information; a pixel number difference ratio is obtained based on a ratio between the pixel number difference and the number of pixels contained in a reference image; when the pixel number difference ratio exceeds a pixel number difference ratio threshold, the group transition direction is determined.

In one embodiment, the determining the pixel number difference based on the difference between the number of pixels in opposite transition directions includes: performing optical flow estimation on the moving object group according to multiple frames to obtain the optical flow displacement of each frame; accumulating the optical flow displacement of each frame to obtain the image movement feature map corresponding to the multiple frames; the image movement feature map includes multiple feature map pixels, and determining the direction of each feature map pixel based on the accumulated result of the optical flow displacement of each frame; according to the direction of each feature map pixel, counting the pixel number of the feature map pixels displaced along the opposite transition directions respectively to obtain the number of pixels in the opposite transition directions. Thus, combined with the optical flow scheme, the number of pixels in the opposite transition directions can be accurately obtained.

In another embodiment, feature points such as corner points and edge points between each frame of image are first detected, and then those feature points in each frame of image are matched based on the combined information of the feature points to obtain matching points. Finally, the moving direction between the matching points is calculated, and the matching points with different moving directions are counted to obtain the number of pixels in the opposite transition directions respectively.

In one embodiment, the determining the pixel number difference based on the difference between the pixel numbers in opposite transition directions includes: performing difference calculation on the pixel number in the previous transition direction and the pixel number in the current transition direction that is the opposite transition direction to the previous transition direction to obtain the pixel number difference.

Correspondingly, when the pixel number difference ratio exceeds the pixel number difference ratio threshold, the determining the group transition direction includes: when the pixel number difference ratio exceeds the pixel number difference ratio threshold, determining the group transition direction as the current transition direction.

In another embodiment, the determining the pixel number difference based on the difference between the pixel numbers in opposite transition directions includes: performing difference calculation on the pixel number in the first transition direction and the pixel number in the second transition direction to obtain the pixel number difference.

Correspondingly, when the pixel number difference ratio exceeds the pixel number difference ratio threshold, determining the group transition direction includes: when the pixel number difference ratio exceeds the pixel number difference ratio threshold, determining the maximum number of pixels between the number of pixels in the first transition direction and the number of pixels in the second transition direction, and determining the group transition direction according to the transition direction where the maximum number of pixels is located.

Therefore, based on the ratio between the pixel number difference and the number of pixels contained in the reference image, the pixel number difference ratio is obtained, which can be adaptively adjusted according to the different sizes of the images taken by the camera, so that the transition judgment is more accurate.

In one embodiment, the acquiring images of the target ball according to the group transition information includes: determining whether the group transition information satisfies image acquisition condition of the target ball; if so, acquiring images according to the group transition information to obtain images of the target ball.

The image acquisition condition is an indicator for image acquisition based on the group transition information. It can be judged whether the group transition information meets the image acquiring condition of the target ball based on the group transition information, or it can be judged whether the group transition information meets the image acquisition condition of the target ball based on the movement scene of the target ball in multiple frames.

In one embodiment, the acquiring the images of the target ball based on the group transition information includes: if the group transition information is used to determine the transition, acquiring the image in a transition direction opposite to the previous transition direction.

In another embodiment, the acquiring images of the target ball based on the group transition information includes: controlling the rotation of the gimbal according to the transition direction contained in the group transition information; acquiring images of the target ball during the rotation of the gimbal; wherein the gimbal rotation may be a preset value or may be dynamically changed.

In one embodiment, after determining whether the group transition information satisfies the image acquisition condition of the target ball, the method further includes: if not, determining the ball transition information according to the ball movement trajectory of the target ball in multiple frames; and performing image acquisition on the target ball based on the ball transition information.

In this embodiment, the target ball is a ball that can be used to control whether the image acquisition process switches. If the image acquisition process is judged to switch based on the position of the target ball alone, its stability is relatively weak, so the target ball can be used as a control factor to judge whether a switch is needed. Optionally, the target ball is a ball determined from the moving ball; the moving ball is a ball identified from multiple balls, and the moving ball is a non-stationary ball.

The ball movement trajectory is a trajectory generated based on the position of the target ball in multiple frames. Optionally, the ball movement trajectory can be a ball region trajectory where the target ball is located; or it can be determined based on ball region trajectory mimicry data used to characterize the movement of the target ball; the ball region trajectory mimicry data is used to reflect the ball movement trajectory of the target ball in multiple frames; the ball region trajectory mimicry data can be data processed by a model used to determine the ball movement trajectory.

The ball transition information is the transition result determined according to the ball movement trajectory. The ball transition information belongs to one of the transition type and non-transition type. The transition type is used to indicate that the image acquisition process requires a transition; the non-transition type is used to determine that the image acquisition process does not require a transition; the ball transition information of the non-transition type can be non-existent data, or it can be represented by some prompt information. Optionally, when the ball motion information meets the transition situation, the ball transition direction, ball transition speed and other information can be determined according to the transition situation that the ball motion information conforms to; when the ball motion information does not conforms to the transition situation, the ball motion information is not used to control the image acquisition.

In one embodiment, the acquiring the images of the target ball based on the ball transition information includes: determining whether the ball movement trajectory of the target ball in multiple frames triggers a transition event; if so, characterizing the transition event to match the transition situation of the ball movement trajectory, and determining the ball transition information of the transition type through the transition situation; if not, obtaining the ball motion information of the non-transition type.

Optionally, the ball transition information can be represented by a transition signal; the transition signal can be used only to represent that the image acquisition process needs a transition, or it can be used to represent that the image acquisition process needs a transition and the corresponding group transition direction. Optionally, the transition signal can be sent by the terminal to the gimbal, or it can be sent by the processor of the gimbal when controlling the movement of its own motor. Optionally, the transition signal used to represent the ball transition information and the transition signal used to represent the group transition information can be the same or different.

In one embodiment, the acquiring the images of the target ball based on the ball transition information includes: if the ball transition information is used to determine the transition, acquiring the image in a transition direction opposite to the previous transition direction.

In another embodiment, the acquiring the images of the target ball based on the ball transition information includes: controlling the rotation of the gimbal according to the transition direction contained in the ball transition information; acquiring images of the target ball during the rotation of the gimbal; wherein the gimbal rotation may be a preset value or may be dynamically changed.

In one embodiment, the controlling the gimbal to rotate according to the transition direction contained in the ball transition information includes: if the transition direction contained in the ball transition information is the first transition direction, controlling the gimbal to rotate in the first transition direction; if the transition direction contained in the ball transition information is the second transition direction, controlling the gimbal to rotate in the second transition direction.

In this embodiment, when the group transition information does not meet the image acquisition condition of the target ball, the ball transition information is determined according to the ball movement trajectory of the target ball in multiple frames, which can avoid the target ball from blocking and affecting the transition judgment, and accurately reflect whether a transition is needed; based on the ball movement scene to which the ball movement trajectory belongs, a transition information is selected from the group transition information and the ball transition information to more accurately judge whether a transition is needed for different ball movement scenes, which can avoid data conflicts between the group transition information and the ball transition information and ensure stable operation.

In one embodiment, the determining the ball transition information according to the ball movement trajectory of the target ball in multiple frames includes: identifying the ball movement trajectory of the target ball according to the multiple frames; determining a target image region and image critical positions in the ball reference image of the multiple frames; if the ball movement trajectory passes through the target image region and there is an image critical position intersecting with the ball movement trajectory, then determining the ball transition direction according to the image critical position intersecting with the ball movement trajectory.

The ball reference image is an image for the target ball, which is the image where the ball movement trajectory of the target ball is located; the ball reference image and the reference image for the group object can be the same or different reference images. The target image region for the target ball is a critical region of varying amplitude of the ball movement trajectory, which is used to determine whether the target ball is within the reference region, and it can be a same region or a different region from the target image region for the group object.

The image critical position is the critical position of the ball reference image, and is used to determine the boundary of the ball reference image. Optionally, the image critical position is a critical line in the direction of a certain side of the ball reference image and perpendicular to the direction of the side; optionally, the image critical position is a critical line in the width direction of the ball reference image and perpendicular to the width direction of the ball reference image; optionally, the image critical position and the above-mentioned transition critical position can be the same or different positions.

In one embodiment, the identifying the ball movement trajectory of the target ball according to multiple frames includes: identifying moving balls according to the ball area trajectories in the multiple frames; determining the target ball from each moving ball according to the confidence that each moving ball belongs to a preset ball type; and determining the ball movement trajectory of the target ball from the ball area trajectories in the multiple frames. Thus, by identifying the moving ball through the ball area trajectories formed by the ball area of multiple frames, the movement trend of the ball can be included in the range of ball detection, static balls are excluded, and the recognition accuracy of the ball area in the image is improved; then, according to the confidence that each moving ball belongs to a preset ball type, the target ball is determined from each moving ball, and the target ball such as a basketball is more accurately identified; in this case, the position information of the target ball is used as a control factor in the image acquisition process, and the group motion information is assisted by this control factor to collect the images of the target ball, so that the automatic shooting process of the target ball is more stable.

Among them, the areas belonging to the same ball that change sequentially in multiple frames can be correlated among the frames to obtain the ball area trajectory of the ball; if the ball area trajectory of the ball represents that the ball is moving, it can be identified that the ball is a moving ball, and then based on whether the characteristics of the moving ball are consistent with the characteristics of the preset ball type, the confidence that the moving ball belongs to the preset ball type is calculated, thereby more accurately identifying a target ball such as a basketball.

In one embodiment, in a ball reference image of multiple frames, the determining the target image region and the image critical positions includes: determining the image center area in the ball reference image of multiple frames, and converting a width of the ball reference image according to an image critical position ratio along the width direction of the ball reference image to obtain an image critical position. The image critical position ratio can be multiplied by the width of the ball reference image to obtain the image critical position.

In one embodiment, determining the ball transition direction according to the image critical position intersecting the ball movement trajectory includes: if the image critical position intersecting the ball movement trajectory is located in the first transition direction of the target image region, then the ball transition direction is determined to be the first transition direction; if the image critical position intersecting the ball movement trajectory is located in the second transition direction of the target image region, then the ball transition direction is determined to be the second transition direction.

Among them, the first transition direction and the second transition direction are opposite directions; exemplarily, when the first transition direction is the left direction, the second transition direction is the right direction; when the first transition direction is the right direction, the second transition direction is the left direction.

In one embodiment, the identifying the ball movement trajectory of the target ball based on multiple frames of images includes: first, using a ball detector to identify the balls in the images frame by frame; wherein the detector scheme includes, but is not limited to, You Only Look Once (YOLO), Single Shot MultiBox (SSD); then, using a multi-target tracking algorithm to assign a tracking ID to each ball, analyzing the moving trajectory of each ID, and filtering out static balls and balls having small movement range on the sidelines to select the target ball sequence with the most significant movement from ball area sequences of multiple balls; generating the ball movement trajectory of the target ball based on the target ball sequence;

Correspondingly, if the ball movement trajectory passes through the target image region and there is an image critical position that intersects with the ball movement trajectory, determining the ball transition direction according to the image critical position that intersects with the ball movement trajectory includes: if the target ball movement trajectory moves significantly from the center to both sides and reaches the image critical position, so that the target ball disappears at the edge of the reference image, it is considered that the basketball has passed out of the reference image from this image critical position of the image. Thus, the transition event is identified, and the algorithm outputs a transition signal.

In another embodiment, the image width of the ball reference image is Width, the image width is the positive direction of the pixel x-axis, the pixel x-axis coordinate interval is (0˜Width), and 0.1*Width and 0.9*Width are set as the critical lines where the image critical positions are located. The tracking trajectory of the target ball in the historical time period (such as 2 seconds) is analyzed. When the ball movement trajectory of the target ball passes through the critical line 0.1*Width from the center area of the image, it is considered that the ball transition direction of the target ball at the current time is to the left; when the ball movement trajectory of the target ball passes through the critical line 0.9*Width from the center area of the image, it is considered that the ball transition direction of the target ball at the current time is to the right.

In this embodiment, the relative position relationship between the target image region and the image critical positions as well as the ball movement trajectory of the target ball are used to estimate whether the ball transition direction exists. Therefore, when the target ball is less obstructed, it is possible to more accurately determine whether the image acquisition process requires a transition, and based on the image critical position intersecting with the ball movement trajectory, the ball transition direction can be more accurately determined.

In one embodiment, the determining whether the group transition information satisfies the image acquisition condition of the target ball includes: determining whether the ball trajectory belongs to a long-trajectory ball movement scene; if so, the group transition information does not meet the image acquisition condition of the target ball; if not, the group transition information meets the image acquisition condition of the target ball.

The ball movement scene is a movement scene determined based on the condition satisfied by the ball movement trajectory. Optionally, the movement scene determined based on the conditions satisfied by the ball movement trajectory can be determined based on the properties of the ball movement trajectory; the properties of the ball movement trajectory include but are not limited to duration, the area passed by the trajectory, etc.

The long-trajectory movement scene is a scene where the ball movement trajectory meets certain condition. The long-trajectory ball movement scene can be judged based on factors such as the duration and length of the ball trajectory itself, and the accuracy of the judgment based on various factors is relatively high. The long-trajectory ball movement scene includes but is not limited to the long pass scene and fast break scene in ball sports.

In one embodiment, the determining whether the ball trajectory belongs to a long-trajectory ball movement scene includes: when the duration of the ball movement trajectory is greater than a long-trajectory time threshold, determining that the ball trajectory belongs to the long-trajectory ball movement scene; when the duration of the ball movement trajectory is less than the long-trajectory time threshold, the duration of the ball movement trajectory is not used for ball movement scene determination.

In another optional implementation, determining whether the ball trajectory belongs to a long-trajectory ball movement scene includes: when the length of the ball movement trajectory is greater than a long-trajectory length threshold, determining that the ball trajectory belongs to the long-trajectory ball movement scene; when the length of the ball movement trajectory is less than the long-trajectory length threshold, the length of the ball movement trajectory is not used for ball movement scene judgment.

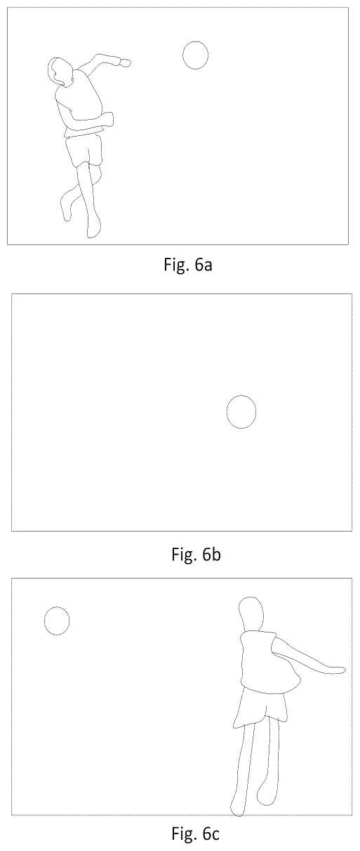

In one embodiment, as shown in FIG. 6, FIG. 6(a), FIG. 6(b) and FIG. 6(c) are executed sequentially. When a certain moving object in FIG. 6(a) throws a ball, an image captured according to the target ball is shown in FIG. 6(b), until the time shown in FIG. 6(c), the target ball approaches a moving object, and the movement of the long-track ball ends.

In the long-trajectory ball movement scene, the target ball is less blocked, and the movement of a person is much slower than that of the ball. The probability of target ball blocking is low, and the ball transition information generated by the ball area trajectory has higher reliability, higher corresponding credibility, and higher transition accuracy. In the case of non-long-trajectory ball movement scenes, the probability of target ball blocking is high, and the group transition information generated for group movement objects has higher reliability, higher corresponding credibility, and higher transition accuracy.

In one embodiment, the acquiring images of a target ball based on group transition information includes: if the group transition information meets the image acquisition conditions of the target ball, adjusting the gimbal speed according to the movement speed in the group motion information to obtain an adjusted gimbal rotation speed; if the group transition information does not meet the image acquisition condition of the target ball, adjusting the gimbal rotation speed according to the movement speed of the target ball to obtain an adjusted gimbal rotation speed; in the process of controlling the rotation of the gimbal according to the adjusted gimbal rotation speed, acquiring the image of the target ball through the gimbal.

In an exemplary embodiment, “transition” refers to identifying the offensive and defensive conversion on the court based on the movement of the crowd and basketball in the court, and then controlling the gimbal to switch from the current half court to the other half court, ensuring that the main people are in the image. The gimbal is placed at the edge of the court midfield, and the crowd movement trend and basketball movement trend in the image are automatically identified by the visual algorithm, and a transition signal is output, thereby controlling the gimbal to switch from the current half court to the other half court, ensuring that the rotation of the gimbal can keep up with the offensive and defensive conversion on the court, and achieving the effect of automatically tracking and shooting the full-court basketball game. Among them, a real-time video stream shot by a user's mobile phone is obtained, the transition recognition algorithm is called for multiple frames continuously, the target movement trend within a period of time is identified, the transition signal is output, and then the gimbal is guided to rotate. The transition recognition algorithm includes but is not limited to the optical flow scheme, the basketball trajectory recognition scheme, the individual position analysis scheme, the group position analysis scheme, and/or the combination of the above schemes. In these solutions, the training materials for a human detector and a basketball detector are mainly based on human materials on the basketball court to ensure the detection rates of players and balls. Based on this, the entire basketball game is automatically tracked and filmed to replace the user's manual camera movement and shooting, realizing unattending function and freeing the user's hands. The solution is different from the existing basketball tracking solution. The key to the algorithm is to identify the transition signal. The “player group” is the most prominent target on the court. Using computer vision processing algorithms to analyze its movement trends can accurately identify the offense and defense transitions on the court. Then, using basketball trajectory information as an aid, it can finally quickly and accurately identify the transition signal and complete the automatic control of the gimbal according to the transition signal.

Alternatively, on an embedded platform or a mobile phone platform with low computing power, the above four solutions can be reasonably matched according to the hardware performance to maximize the use of the platform computing power and obtain the highest transition recognition accuracy. Optionally, a manual camera movement button can be designed to take manual intervention measures in scenarios such as stealing and other scenarios that cause the transition signal to fail.

Therefore, in one case, the gimbal rotation speed is adjusted according to the movement speed in the group motion information so that the gimbal rotation speed moves synchronously with the crowd; in another case, the gimbal rotation speed is adjusted according to the movement speed of the target ball so that the gimbal rotation speed moves synchronously with the target ball.

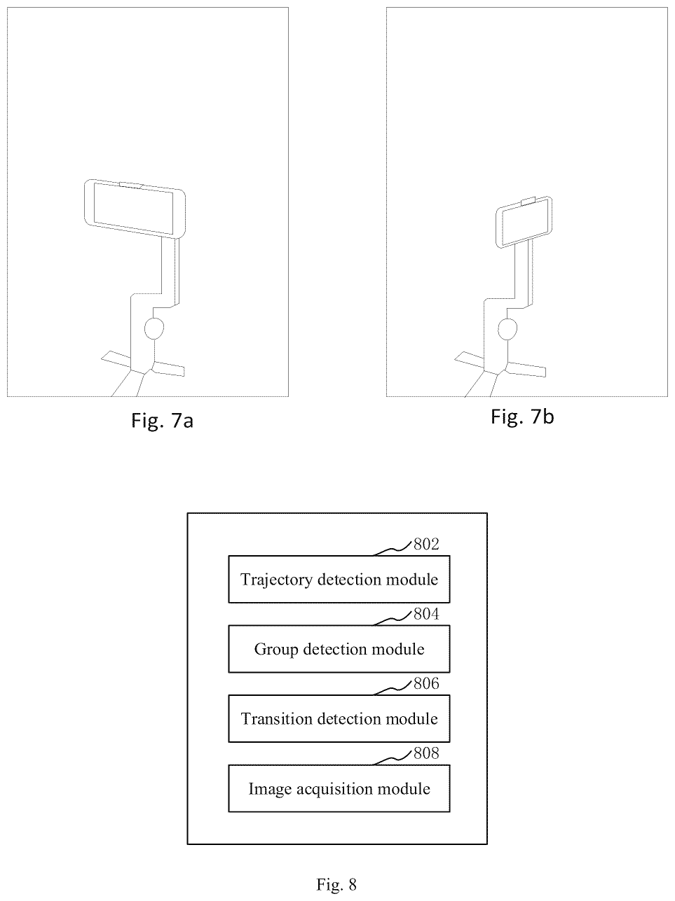

In an exemplary embodiment, as shown in FIG. 7, after the mobile phone is mounted on the gimbal, when the corresponding scheme of any of the above embodiments is executed by the mobile phone, the gimbal is controlled to rotate to change the direction of the mobile phone camera, so as to collect the images of the target ball. At this time, when acquiring images toward one half of the field, the gimbal and the mobile phone are as shown in FIG. 7(a), and when acquiring images toward the other half of the field, the gimbal and the mobile phone are as shown in FIG. 7(b); during the image collection process between FIG. 7(a) and FIG. 7(b), the gimbal rotates continuously.

It should be understood that, although the steps in the flowcharts involved in the above embodiments are displayed in sequence according to the indication of the arrows, these steps are not necessarily executed in sequence according to the order indicated by the arrows. Unless there is a clear explanation in this article, the execution of these steps is not strictly limited in order, and these steps can be executed in other orders. Moreover, at least a part of the steps in the flowcharts involved in the above embodiments may include multiple steps or multiple stages, and these steps or stages are not necessarily executed at the same time, but can be executed at different times, and the execution order of these steps or stages is not necessarily carried out in sequence, but can be executed in turn or alternately with other steps or at least a part of the steps or stages in other steps.

Based on similar inventive concept, one embodiment of the present application also provides a target ball image acquisition device for implementing the target ball image acquisition method involved above. The implementation scheme for solving the problem provided by the device is similar to the implementation scheme recorded in the above method, so the specific limitations of the one or more target ball image acquisition device embodiments provided below can refer to the limitations of the target ball image acquisition method above, and will not be repeated here.

In an exemplary embodiment, as shown in FIG. 8, a gimbal recorder is provided, comprising:
a trajectory detection module 802, configured to detect the movement trajectory of each moving object in the moving object group according to multiple frames;
a group detection module 804, configured to determine group motion information of a moving object group according to the movement trajectory of each of the moving objects;
a transition detection module 806, configured to determine group transition information according to a transition situation that the group motion information conforms to;
an image acquisition module 808, configured to acquire images of the target ball according to the group transition information.

In one embodiment, the group detection module 804 is configured to:
determine a target image region and different transition critical positions in a reference image of the multiple frames; and
among the movement trajectories of the moving objects passing through the target image region, counting the movement trajectories of the moving objects intersecting at the different transition critical positions respectively to obtain the number of moving objects in different transition directions.

Correspondingly, the transition detection module 806 is configured to:
determine the group transition information according to a transition interval to which the number of moving objects in different transition directions belongs.

In one embodiment, a critical value of the transition interval includes a first critical value and a second critical value, and the first critical value is greater than the second critical value.

The transition detection module 806 is configured to:
if the number of moving objects in the first transition direction is greater than the first critical value, and the number of moving objects in the second transition direction is less than the second critical value, determine the first transition direction to be the group transition direction; and
if the number of moving objects in the first transition direction is less than the second critical value, and the number of moving objects in the second transition direction is greater than the first critical value, determine the second transition direction to be the group transition direction,
wherein the first transition direction and the second transition direction are opposite directions.

In one embodiment, the group detection module 804 is configured to:
determine the individual position of each of the moving objects at the same time according to the moving trajectory of each of the moving objects at different times;
generate a group position at the same time according to the individual positions of the objects at the same time; and
generate group displacements of at least two groups of adjacent times according to the group positions of the group of the at least two groups of adjacent times.

Correspondingly, the transition detection module 806 is configured to:
if the group displacements of at least two groups of adjacent times have the same transition direction, and in the same transition direction, the group displacements of at least two groups of adjacent times respectively exceed a transition length threshold, determine that the group transition information includes the same transition direction.

In one embodiment, when the group motion information includes the number of moving objects in different transition directions and does not include group displacements of at least two groups of adjacent times, the transition interval used to determine the transition situation is the first transition interval;

When the group motion information does not include the number of moving objects in different transition directions and includes group displacements of at least two groups of adjacent times, the transition length threshold used to determine the transition situation is a first transition length threshold;

In a case where the group motion information includes the number of moving objects in different transition directions and includes group displacements of at least two groups of adjacent times, the transition interval is a second transition interval, and the transition length threshold is a second transition length threshold;

The first transition interval covers the second transition interval, and the range of the first transition interval is smaller than the range of the second transition interval, and the first transition length threshold is greater than the second transition length threshold.

In one embodiment, the transition detection module 806 is configured to:
when the group motion information does not meet the group transition information generation condition, perform optical flow estimation on the moving object group according to the multiple frames to obtain the optical flow displacement of each frame;
accumulating the optical flow displacement of the image of each frame to obtain an image movement feature map corresponding to the multiple frames; the image movement feature map includes a plurality of feature map pixels, and the direction of each feature map pixel is determined by the accumulation result of the optical flow displacement of the image of each frame;
according to the directions of the feature map pixels, the number of feature map pixels that are displaced along the opposite transition directions is counted to obtain the number of pixels in the opposite transition directions respectively; and
determine a comparison result between the numbers of pixels in opposite transition directions; the comparison result pertaining to the group motion information.

In one embodiment, the transition detection module 806 is configured to:
when the group motion information does not meet the group transition information generation condition, determine a pixel quantity difference based on a difference between the numbers of pixels in opposite transition directions; the number of pixels in the opposite transition directions is obtained based on the multiple frames;
obtain a pixel quantity difference ratio based on a quantity ratio between the pixel quantity difference value and the quantity of pixels included in the reference image;
when the pixel quantity difference ratio exceeds a pixel quantity difference ratio threshold, determine the group transition direction.

In one embodiment, the transition detection module 806 is configured to:
in a case that the movement trajectories of the plurality of moving objects are detected according to multiple frames of images, determine that the movement trajectories of the multiple moving objects satisfy a small number trajectory condition; and/or detect that the plurality of frames of images satisfy a reference object lacking condition.

In one embodiment, the image acquisition module 808 is configured to:
determine whether the group transition information satisfies the image acquisition condition of the target ball;
if the condition is met, perform image acquisition according to the group transition information to obtain images of the target ball.

In one embodiment, the image acquisition module 808 is configured to:
if not, determine the ball transition information according to the ball movement trajectory of the target ball in the plurality of frames of images; and
according to the ball transition information, acquire the images of the target ball.

In one embodiment, the image acquisition module 808 is configured to:
identify the ball movement trajectory of the target ball according to the multiple frames of images;
determine a target image region and image critical positions in the ball reference image of the multiple frames of images;
if the ball movement trajectory passes through the target image region and there is an image critical position intersecting with the ball movement trajectory, determine the ball transition direction according to the image critical position intersecting with the ball movement trajectory.

In one embodiment, the image acquisition module 808 is configured to:
identify the moving balls according to the trajectory of the ball areas in multiple frames of images;
determine a target ball from each of the moving balls according to the confidence that each of the moving balls belongs to a preset ball type;
determine the ball movement trajectory of the target ball from the ball area trajectories in the multiple frames of images.

In one embodiment, the image acquisition module 808 is configured to:
determine whether the ball trajectory belongs to a long-trajectory ball movement scene;
if yes, determine that the group transition information does not meet the image acquisition condition of the target ball;
if not, determine that the group transition information satisfies the image acquisition condition of the target ball.

In one embodiment, the image acquisition module 808 is configured to:
if the group transition information satisfies the image acquisition condition of the target ball, adjust the gimbal speed according to the movement speed in the group motion information to obtain an adjusted gimbal rotation speed; and
if the group transition information does not meet the image acquisition condition of the target ball, adjust the gimbal rotation speed according to the movement speed of the target ball to obtain an adjusted gimbal rotation speed.

In the process of controlling the rotation of the gimbal according to the adjusted gimbal speed, the images of the target ball are collected through the gimbal.

In one of the embodiments, the process of acquiring the images of the target ball is performed through a gimbal, and the gimbal is provided with a camera movement button.

The above-mentioned target ball image acquisition device can be implemented in whole or in part by software, hardware or a combination thereof. Each of the above-mentioned modules can be embedded in or independent of a processor in a computer device in the form of hardware, or can be stored in a memory in a computer device in the form of software, so that the processor can call and execute operations corresponding to each of the above modules.

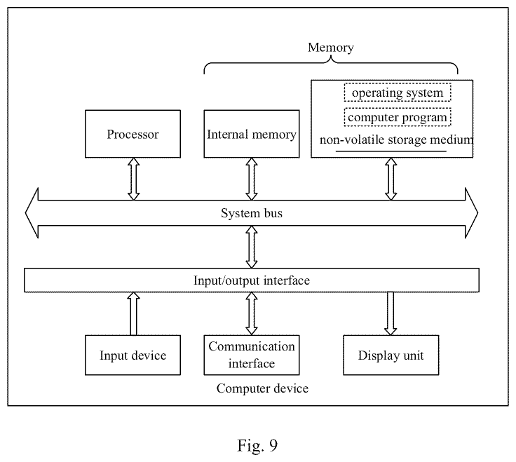

In an exemplary embodiment, a computer device is provided, which may be a terminal, and its internal structure diagram may be shown in FIG. 9. The computer device includes a processor, a memory, an input/output interface, a communication interface, a display unit, and an input device. The processor, the memory, and the input/output interface are connected via a system bus, and the communication interface, the display unit, and the input device are connected to the system bus via the input/output interface. The processor of the computer device is configured to provide computing and control capabilities. The memory of the computer device includes a non-volatile storage medium and an internal memory. The non-volatile storage medium stores an operating system and a computer program. The internal memory provides an environment for the operation of the operating system and the computer program in the non-volatile storage medium. The input/output interface of the computer device is used to exchange information between the processor and an external device. The communication interface of the computer device is used to communicate with an external terminal in a wired or wireless manner, and the wireless manner may be implemented through WIFI, a mobile cellular network, near field communication (NFC) or other technologies. When the computer program is executed by the processor, a method for acquiring a image of a target ball is implemented. The display unit of the computer device is used to form a visually visible image, which may be a display image, a projection device, or a virtual reality imaging device. The display image can be a liquid crystal display image or an electronic ink display image, and the input device of the computer device can be a touch layer covering the display image, or a button, trackball or touchpad set on the computer device shell, or an external keyboard, touchpad or mouse.

Those skilled in the art will understand that the structure shown in FIG. 9 is merely a block diagram of a partial structure related to the solution of the present application, and does not constitute a limitation on the computer device to which the solution of the present application is applied. The specific computer device may include more or fewer components than shown in the figure, or combine certain components, or have a different arrangement of components.

In one embodiment, a handheld gimbal is provided, including a motor and a processor, wherein the motor is used to control the rotation of the gimbal, and the processor implements the steps of acquiring the image of the target ball in any of the above embodiments when executing a computer program.

In one embodiment, a handheld gimbal is provided, including a motor for controlling the rotation of the gimbal. A terminal processor installed on the handheld gimbal is used to implement the steps of acquiring the image of the target ball in any of the above embodiments when executing a computer program.

In one embodiment, a computer device is further provided, including a memory and a processor, wherein a computer program is stored in the memory, and the processor implements the steps in the above method embodiments when executing the computer program.

In one embodiment, a computer-readable storage medium is provided, on which a computer program is stored. When the computer program is executed by a processor, the steps in the above-mentioned method embodiments are implemented.

In one embodiment, a computer program product is provided, including a computer program, which implements the steps in the above method embodiments when executed by a processor.

It should be noted that the user information (including but not limited to user device information, user personal information, etc.) and data (including but not limited to data used for analysis, stored data, displayed data, etc.) involved in this application are all information and data authorized by the user or fully authorized by all parties, and the collection, use and processing of relevant data must comply with relevant regulations.

A person of ordinary skill in the art can understand that all or part of the processes in the above-mentioned embodiments can be completed by instructing the relevant hardware through a computer program, and the computer program can be stored in a non-volatile computer-readable storage medium. When the computer program is executed, it can include the processes of the embodiments of the above-mentioned methods. Among them, any reference to the memory, database or other medium used in the embodiments provided in the present application can include at least one of non-volatile and volatile memory. Non-volatile memory can include read-only memory (ROM), magnetic tape, floppy disk, flash memory, optical memory, high-density embedded non-volatile memory, resistive random access memory (ReRAM), magnetic random access memory (MRAM), ferroelectric random access memory (FRAM), phase change memory (PCM), graphene memory, etc. Volatile memory can include random access memory (RAM) or external cache memory, etc. As an illustration and not limitation, RAM can be in various forms, such as static random access memory (SRAM) or dynamic random access memory (DRAM). The database involved in each embodiment provided in this application may include at least one of a relational database and a non-relational database. Non-relational databases may include distributed databases based on blockchains, etc., but are not limited to this. The processor involved in each embodiment provided in this application may be a general-purpose processor, a central processing unit, a graphics processor, a digital signal processor, a programmable logic unit, a data processing logic unit based on quantum computing, circuitry etc., but are not limited to this.

The technical features of the above embodiments may be combined arbitrarily. To make the description concise, not all possible combinations of the technical features in the above embodiments are described. However, as long as there is no contradiction in the combination of these technical features, they should be considered to be within the scope of this specification.

The above-described embodiments only express several implementation methods of the present application, and the descriptions thereof are relatively specific and detailed, but they cannot be understood as limiting the scope of the present application. It should be pointed out that, for a person of ordinary skill in the art, several variations and improvements can be made without departing from the concept of the present application, and these all belong to the protection scope of the present application. Therefore, the protection scope of the present application shall be subject to the attached claims.

What is claimed is:

1. A method for controlling a gimbal recorder to record a game, comprising:
detecting motion information of moving objects in a moving object group and motion information of a target ball in the game, the moving objects comprising players of the game;
determining group motion information of the moving object group according to the motion information of the moving objects;
determining transition information according to the group motion information of the moving object group and/or the motion information of the target ball; and
controlling at least one of orientation or shooting parameters of the gimbal recorder according to the transition information.

2. The method according to claim 1, wherein the determining the group motion information of the moving object group according to the motion information of the moving objects comprises:
determining different transition critical positions in a reference image of multiple frames of images captured by the recording equipment;
determining movement trajectories of the moving objects according to the motion information of the moving objects; and
counting the movement trajectories of the moving objects intersecting the different transition critical positions to correspondingly obtain a number of moving objects in different transition directions respectively, and
wherein the determining the transition information according to the group motion information of the moving object group includes:
determining group transition information according to a transition interval to which the number of moving objects in different transition directions belongs.

3. The method according to claim 2, wherein a critical value of the transition interval includes a first critical value and a second critical value, and the first critical value is greater than the second critical value;
the determining the group transition information according to the transition interval to which the number of moving objects in different transition directions belongs includes:
if the number of moving objects in a first transition direction is greater than the first critical value and the number of moving objects in a second transition direction is less than the second critical value, determining the first transition direction to be a group transition direction; and
if the number of moving objects in the first transition direction is less than the second critical value and the number of moving objects in the second transition direction is greater than the first critical value, determining the second transition direction to be the group transition direction,
wherein the first transition direction and the second transition direction are opposite directions.

4. The method according to claim 1, wherein the determining the group motion information of the moving object group according to the motion information of the moving objects comprises:
determining movement trajectories of the moving objects according to the motion information of the moving objects;
determining individual positions of the moving objects at a same time according to the moving trajectories of the moving objects at different times;
generating a group position at the same time according to the individual positions of the moving objects at the same time; and
generating group displacements of at least two groups of adjacent times according to group positions of the moving object group of the at least two groups of adjacent times, and
wherein the determining the transition information according to the group motion information of the moving object group includes:
if the group displacements of the at least two groups of adjacent times have a same transition direction, and in the same transition direction, the group displacements of the at least two groups of adjacent times respectively exceed a transition length threshold, determining that the transition information includes the same transition direction.

5. The method according to claim 1, wherein, when the group motion information includes a number of moving objects in different transition directions and does not include group displacements of at least two groups of adjacent times, a transition interval used to determine the transition information is a first transition interval;
when the group motion information does not include the number of moving objects in different transition directions and includes the group displacements of at least two groups of adjacent times, a transition length threshold used to determine the transition information is a first transition length threshold;
in a case where the group motion information includes the number of moving objects in different transition directions and includes the group displacements of at least two groups of adjacent times, the transition interval used to determine the transition information is a second transition interval, and the transition length threshold used to determine the transition information is a second transition length threshold; and
a range of the first transition interval is smaller than a range of the second transition interval, and the first transition length threshold is greater than the second transition length threshold.

6. The method according to claim 1, wherein the determining the group motion information of the moving object group according to the motion information of the moving objects comprises:
performing optical flow estimation on the moving object group according to multiple frames of images captured by the recording equipment to obtain optical flow displacement of each of the multiple frames of images;
accumulating the optical flow displacement of each of the multiple frames of images to obtain an image movement feature map corresponding to the multiple frames of images, wherein the image movement feature map includes a plurality of feature map pixels, and a direction of each of the feature map pixels is determined by accumulation result of the optical flow displacement of each of the frames of images;
counting a number of feature map pixels that are displaced along opposite transition directions according to the direction of each of the feature map pixels to obtain the number of feature map pixels in the opposite transition directions respectively; and
determining a comparison result between the numbers of pixels in the opposite transition directions, the comparison result belonging to the group motion information.

7. The method according to claim 6, wherein the determining the transition information according to the group motion information of the moving object group includes:
determining a pixel quantity difference based on a difference between the numbers of feature map pixels in the opposite transition directions;
obtaining a pixel quantity difference ratio based on a quantity ratio between a value of the pixel quantity difference and a value of a quantity of pixels included in the reference image; and
when the pixel quantity difference ratio exceeds a pixel quantity difference ratio threshold, determining the group transition direction based on the pixel quantity difference ratio.

8. The method according to claim 1, wherein the determining the transition information according to the motion information of the target ball comprises:
determining ball transition information according to ball movement trajectory of the target ball in the multiple frames of images.

9. The method according to claim 8, wherein the determining the ball transition information according to the ball movement trajectory of the target ball in the multiple frames of images comprises:
identifying ball movement trajectory of the target ball according to the multiple frames of images;
determining image critical positions in a ball reference image of the multiple frames of images;
determining the ball transition direction according to the one of the image critical positions intersecting with the ball movement trajectory.

10. The method according to claim 8 wherein the identifying the ball movement trajectory of the target ball according to the multiple frames of images comprises:
identifying moving balls according to ball area trajectories in the multiple frames of images;
determining the target ball from the moving balls according to a confidence that each of the moving balls belongs to a preset ball type; and
determining the ball movement trajectory of the target ball from the ball area trajectories in the multiple frames of images.

11. The method according to claim 1, wherein the controlling at least one of orientation or shooting parameters of the gimbal recorder according to the transition information comprises:
if the transition information is determined according to the group motion information of the moving object group, controlling one or more of a rotation direction, a rotation angle or a rotation speed of a gimbal supporting a recorder in the gimbal recorder according to a moving direction and moving speed of the moving object group; and
if the transition information is determined according to the motion information of the target ball, controlling one or more of a rotation direction, a rotation angle or a rotation speed of the gimbal supporting the recorder in the gimbal recorder according to a moving direction and a movement speed of the target ball.

12. A gimbal, comprising:
at least one memory to store a computer program; and
at least one processor configured to, when executing the computer program:
detect motion information of moving objects in a moving object group and motion information of a target ball in the game, the moving objects comprising players of the game;
determine group motion information of the moving object group according to the motion information of the moving objects;
determine transition information according to the group motion information of the moving object group and/or the motion information of the target ball; and
control at least one or more of a rotation direction, a rotation angle or a rotation speed of the gimbal according to the transition information.

13. A gimbal recorder, comprising:
a recorder to capture a video of a game;
a gimbal to control orientation and/or shooting parameters of the recorder;
at least one memory to store a computer program; and
at least one processor configured to, when executing the computer program:
detect motion information of moving objects in a moving object group and motion information of a target ball in the game, the moving objects comprising players of the game;
determine group motion information of the moving object group according to the motion information of the moving objects;
determine transition information according to the group motion information of the moving object group and/or the motion information of the target ball; and
controlling at least one of the orientation or shooting parameters of the recorder according to the transition information.

14. The gimbal recorder according to claim 13, wherein the controlling at least one of the orientation or shooting parameters of the recorder according to the transition information comprises:
if the transition information is determined according to the group motion information of the moving object group, controlling at least one or more of a rotation direction, a rotation angle or a rotation speed of the gimbal according to a moving direction and moving speed of the moving object group; and
if the transition information is determined according to the motion information of the target ball, controlling at least one or more of a rotation direction, a rotation angle or a rotation speed of the gimbal according to a moving direction and a movement speed of the target ball.

15. The gimbal recorder according to claim 13, wherein the group motion information of the moving object group is determined according to optical flow displacement of each of multiple frames of images captured by the recording device.

16. The gimbal recorder according to claim 13, wherein the group motion information of the object group is determined according to a multi-target tracking method.

17. The gimbal recorder according to claim 13, wherein the transition information is determined according to ball movement trajectory of the target ball in multiple frames of images captured by the recorder.

18. The gimbal recorder according to claim 13, wherein the gimbal comprises a handheld portion and a gimbal portion, wherein the gimbal portion is disposed on the handheld portion.

19. The gimbal recorder according to claim 18, wherein the handheld portion comprises buttons for controlling the orientation and shooting parameters of the recorder.

20. The gimbal recorder according to claim 18, wherein the recorder is a mobile phone or a camera.
